(19) United States
(12) Patent Application Publication
(10) Pub. No.: US 2025/0109293 A1
(43) Pub. Date: Apr. 3, 2025

(54) SHELLAC-CONTAINING AQUEOUS POLYMER EMULSIONS AND COATINGS FORMED THEREWITH

(71) Applicant: Michelman, Inc., Cincinnati, OH (US)

(72) Inventors: Christopher MOST, Edgewood, KY (US); Becky McCLOSKEY, Loveland, OH (US); Hong ZHANG, Mason, OH (US); Qiaoqiao GAN, Shanghai (CN); Jim STEPHENS, Cincinnati, OH (US); Ted PORTER, Cincinnati, OH (US); Tyler Alan REECE, Cincinnati, OH (US)

(73) Assignee: Michelman, Inc., Cincinnati, OH (US)

(21) Appl. No.: 18/730,563

(22) PCT Filed: Jan. 26, 2023
(86) PCT No.: PCT/US2023/061393

§ 371 Date: Jul. 19, 2024

Related U.S. Application Data
(60) Provisional application No. 63/304,028, filed on Jan. 28, 2022.

(51) Int. Cl. C08L 91/06; A01C 1/06; C08K 3/011; C08K 5/09; C09D 5/02; C09D 191/06

(52) U.S. Cl. CPC C08L 91/06; A01C 1/06; C08K 3/011; C08K 5/09; C09D 5/022; C09D 191/06; C08L 2201/52; C08L 2205/035

(57) ABSTRACT

Coatings may be used to discourage agglomeration and dust formation when handling seeds. Aqueous emulsions suitable for coating seeds and other substrates may comprise an aqueous fluid, a wax, and a polymer blend comprising shellac, a film-forming polymer that is water-soluble or biodegradable, and, optionally, a plasticizer, in which the wax is emulsified as solids in the aqueous fluid and the polymer blend is at least partially dissolved in the aqueous fluid. Optionally, the aqueous emulsions may comprise at least one effect pigment and/or at least one crosslinking agent. The wax and/or the plasticizer may also be naturally sourced as well. Thin-film coatings upon seeds or other substrates may comprise the wax and the polymer blend, in which the shellac is distributed as a continuous phase in the thin-film coating.

### BACKGROUND

Dust formation can be problematic in a number of industries, with consequences of dust formation ranging from mere nuisance to severe health and safety hazards. Like many small particles, dust represents a potential inhalation hazard that may lead to adverse health effects, and under certain circumstances fine dust particles may be subject to flash ignition.

Handling and planting of seeds represents one area where dust formation may be problematic. For example, seed sowing equipment may lead to dust drift. Seeds may also be inherently prone to dust formation, since they may be small particles or contain small particles. Dust drift, also referred to as dust off, is a measure of the loss of particles from seeds when the seeds are handled. High dust off values are representative of excessive dust formation, Excessive dust off may liberate active ingredients from seeds or a coating thereon, such as fertilizers or herbicides, and thus impact crop growing efficacy. Moreover, studies have shown that excess dust formation during seed planting may have negative environmental impacts, such as having a deleterious effect on local honey bee populations.

Another issue commonly encountered when using seed sowing equipment is that of flowability, which refers to the ease with which dry seeds slide through internals of the seed sowing equipment. Low flowability values may lead to issues such as, for example, clumping of the seeds (sometimes referred to in the art as “bridging”), plugging of the seed sowing equipment in various locations, inconsistent seed flow through the seed sowing equipment, and uneven planting of the seeds, including placement of multiple seeds per hole or missing seeds in some holes. All of these factors may lead to inconsistent or sub-optimal planting of a given plot of farmland and, in turn, an undesired loss of crop yield.

To discourage the formation of dust and to encourage ready flowability, coatings are frequently applied to seeds, as well as to other types of substances that are prone to dust formation. Polymer coatings are frequently utilized for this purpose. Although polymer coatings may suppress dust formation and promote increased flowability in some cases, many polymer coatings are not readily dissolvable or biodegradable and thus may persist as microplastics in the environment for extended periods of time. Indeed, the environmental issues associated with microplastics are so impactful, the European Union has mandated a phase out of seed coatings capable of generating microplastics by the mid-2020s, and it is expected that other countries may follow suit in the coming years.

As a further issue, many coatings are unable to deliver satisfactory dust off and flow performance in combination with one another, especially those that extensively utilize bio-sourced or biodegradable materials. Many conventional bio-sourced components for seed coatings and other types of coatings are experiencing ongoing supply chain issues or may deliver coating performance that is less than desired. Thus, there is a desire to render coatings for seeds and other surfaces more readily biodegradable and/or environmentally friendly by utilizing higher percentages of (or exclusively) bio-sourced materials that are easily sourced while concurrently realizing coatings having exceptional performance for their intended application.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to one having ordinary skill in the art and having the benefit of this disclosure.

FIG. 1 is a diagram of an illustrative system for coating seeds using a drum coater according to various embodiments of the present disclosure.

FIG. 2 is a plot of dry flow performance of seeds coated using the aqueous emulsions of Samples 1-4.

FIG. 3 is a plot of Heubach dust off performance of seeds coated using the aqueous emulsions of Samples 1-4.

FIG. 4 is a plot of dry flow performance of seeds coated using the aqueous emulsions of Samples 5-8.

FIG. 5 is a plot of Heubach dust off performance of seeds coated using the aqueous emulsions of Samples 5-8.

FIG. 6 is a plot of dry flow performance of seeds coated using the aqueous emulsions of Samples 9 and 10.

FIG. 7 is a plot of Heubach dust off performance of seeds coated using the aqueous emulsions of Samples 9 and 10.

### DETAILED DESCRIPTION

The present disclosure generally relates to emulsion and coating technologies and, more specifically, aqueous emulsions and coatings formed therefrom that may lack microplastic-generating components.

As discussed above, dust formation may be problematic in various respects, including when handling and planting seeds. Polymer-containing seed coatings and other types of polymer coatings may promote ready flowability and suppress dust formation to varying degrees, but many types of such polymer coatings may be based on chemistries or technologies that render them as microplastics. As used herein, the term “microplastics” refers to polymer particles having a maximum size of about 5 mm in any dimension, wherein the polymer is non-biopolymer in nature (i.e., not naturally occurring), water-insoluble and non-biodegradable. Because microplastics are a growing environmental concern, polymer coatings that are defined as microplastics are currently being phased out. At present, there are few viable alternatives for suppressing dust formation and promoting ready flowability when forming coatings upon seeds and other types of surfaces, particularly using microplastics-free compositions.

The present disclosure provides aqueous emulsions and coatings formed therefrom that may incorporate polymers that are either 1) water-soluble or biodegradable synthetic polymers, and/or 2) naturally occurring biopolymers, preferably without further chemical modifications, which need not necessarily be water-soluble or biodegradable. In the disclosure herein, a material is considered to be water-soluble if the material has an aqueous solubility of about 2 g/L or greater at room temperature. Biodegradation may be established by OECD test method 301D. Other standard test methods for determining biodegradation include OECD test methods 301B, C, or F or OECD test method 310. In either case, the aqueous emulsions and coatings are not substantially based on chemistries that are defined as microplastics and may persist in the environment for extended periods of time. Advantageously, the aqueous emulsions may incorporate other biologically sourced materials (including all biologically sourced materials in some instances) that maintain the environmental favorability and also promote formation of robust polymer coatings when the aqueous emulsions have dried upon various types of surfaces. In some embodiments, the aqueous emulsions may be microplastics-free and afford coatings that are likewise microplastics-free.

Advantageously, coatings formed from the aqueous emulsions of the present disclosure may also suppress dust formation and promote ready flowability when incorporated as a coating upon various types of seeds. Performance of the coatings in these respects may be at least comparable to common coating materials that contain microplastics. As such, the aqueous emulsions of the present disclosure and coatings formed therefrom represent a potentially disruptive technology for formation of seed coatings and other types of coatings. Because naturally occurring biopolymers are employed in the aqueous emulsions and coatings disclosed herein, they are more environmentally sustainable and renewable than are present technologies. Although the aqueous emulsions of the present disclosure may be particularly advantageous for coating seeds, it is to be appreciated that the aqueous emulsions may be suitable for forming coatings upon other types of substrates as well.

Aqueous emulsions of the present disclosure may comprise: an aqueous fluid, a wax, and a polymer blend comprising shellac, a film-forming polymer that is water-soluble or biodegradable, and, optionally, a plasticizer. That is, the plasticizer may or may not be present in the aqueous emulsions and coatings formed therefrom. Advantaged performance may be realized when the plasticizer is present. The wax may comprise one or more waxes, and the film-forming polymer may comprise one or more polymers. The wax and the polymer blend are dispersed in the aqueous fluid. As used herein, the term “dispersed” refers to a substance being dissolved as a solution or being suspended as small particles in an emulsion. The wax and the plasticizer may also be biologically sourced, as discussed in additional detail below. Advantageously, the plasticizer (if present) and the shellac may interact with each other and the film-forming polymer to produce a robust coating. Coatings lacking the plasticizer tend to be somewhat more brittle, but they may afford acceptable performance in some cases.

In some instances, the wax may be omitted from the aqueous emulsions, in which case the aqueous emulsions may comprise an aqueous fluid and a polymer blend comprising shellac, a film-forming polymer that is water-soluble or biodegradable, and, optionally, a plasticizer. All of these components may be at least partially dissolved in the aqueous fluid.

In more specific examples, the wax may be dispersed by being emulsified as solids in the aqueous fluid (e.g., as a plurality of solid particles dispersed in the aqueous fluid) and the polymer blend (i.e., the shellac, the first film-forming polymer, and the optional plasticizer) may be dispersed by being at least partially dissolved in the aqueous fluid. Accordingly, in more specific embodiments, aqueous emulsions of the present disclosure may comprise: an aqueous fluid, a wax, and a polymer blend comprising shellac, a film-forming polymer that is water-soluble or biodegradable, and, optionally, a plasticizer, in which the wax is emulsified as solids in the aqueous fluid, and the polymer blend is at least partially dissolved in the aqueous fluid.

Aqueous fluids suitable for use in the present disclosure may comprise water or water admixed with a water-miscible organic solvent, such as an alcohol or a glycol. Such water-miscible organic solvents may sometimes be present as an anti-freeze agent by lowering the freezing point of the aqueous fluid. The aqueous fluids and aqueous emulsions may be acidic, neutral, or basic, depending upon particular application needs. A particular pH may be chosen to maintain the emulsion in emulsified form or to afford a particular protonation state for one or more components of the emulsion, for example. Buffering may be conducted, if needed or desired. As such, the aqueous fluids and aqueous emulsions formed therefrom may have a pH ranging from about 1 to about 7, or about 2 to about 6, or about 1 to about 6, or about 6 to about 7, or about 6 to about 8, or about 7 to about 8, or about 7 to about 14, or about 8 to about 14, or about 8 to about 12, or about 7 to about 9.

The aqueous fluid may be present in the aqueous emulsions described herein in an amount up to about 90 wt. %, or up to about 80 wt. %, or up to about 70 wt. %, or up to about 60 wt. %, or up to about 50 wt. %, or up to about 40 wt. %, or up to about 30 wt. %, or up to about 20 wt. %, or up to about 15 wt. %, such as about 5 wt. % to about 20 wt. %, or about 10 wt. % to about 25 wt. %, or about 10 wt. % to about 30 wt. %, or about 15 wt. % to about 25 wt. %, or about 50 wt. % to about 80 wt. %, each as measured based on total mass of the aqueous emulsions.

The aqueous emulsions described herein may contain a high loading of total solids, some of which may be at least partially dissolved in the aqueous fluid and some of which may be dispersed as solids in the aqueous fluids. As used herein, the term “solids” refers to any non-liquid component dispersed within a given aqueous fluid, either in an at least partially dissolved form or in a particulate (undissolved/emulsified/dispersed form). For instance, in non-limiting examples, wax particles may be dispersed as solids in the aqueous fluids and the first film-forming polymer and shellac may be at least partially dissolved in the aqueous fluid in the aqueous emulsions disclosed herein.

In illustrative embodiments, the aqueous emulsions described herein may contain about 5 wt. % to about 60 wt. % total solids, or about 10 wt. % to about 60 wt. % total solids, or about 15 wt. % to about 55 wt. % total solids, or about 20 wt. % to about 50 wt. % total solids, or about 35 wt. % to about 55 wt. % total solids, based on total mass of the aqueous emulsion. Total solids refer to both dissolved solids and emulsified solids, including dispersed solids. The aqueous fluid may constitute the balance of mass within the aqueous emulsions. Solids present in particulate form (emulsified/dispersed solids) may be present in the aqueous emulsions in particle sizes ranging from about 50 nm to about 5 μm in size or about 100 nm to about 5 μm in size, for example, within the aqueous emulsions described herein.

In non-limiting examples the ratio of dissolved solids to particulate solids in the aqueous emulsions may range from about 2:3 to about 3:2, or about 1:1 to about 3:1, or about 1:1 to about 4:1, or about 1:1 to about 3:2, each on a mass basis. Preferably, dissolved solids are present in a greater amount than particulate solids. Dissolved solids may include at least shellac and the film-forming polymer. Particulate solids may include the wax. In some or other examples, a ratio of film-forming polymer to wax may range from about 1:1 to about 1:10, or about 1:2 to about 1:8, or about 1:4 to about 1:6, each on a mass basis. In some or other examples, a ratio of shellac to wax may range from about 2:3 to about 3:2, or about 1:1 to about 2:3, each on a mass basis.

Waxes are hydrophobic organic substances that occur in petroleum and other oleaginous materials, are biosynthesized by plants and animals, or are obtained synthetically. Waxes are usually malleable solids at room temperature and may comprise one or more higher alkanes (paraffins), particularly normal or branched C₁₆-C₁₀₀ alkanes or C₂₀-C₅₀ alkanes, lipids and/or oils. Suitable waxes for use in the disclosure herein may include, but are not limited to, paraffin waxes, oxidized paraffin waxes, polyolefin waxes, oxidized polyolefin waxes, natural waxes, oxidized natural waxes, and any combination thereof. In addition, waxy components obtained from de-waxed shellac (i.e., shellac wax) may be present in the aqueous emulsions disclosed herein, either with or without other waxes being present. As used herein, a wax is considered “oxidized” if oxygenated functional groups such as alcohols, carboxylic acids, epoxides or the like are introduced to an otherwise unsubstituted (paraffinic) hydrocarbon backbone. The amount of oxygenated functional groups introduced to a particular wax may, for example, be sufficient to lower the hydrophobicity of the wax to an extent necessary to facilitate formation of an emulsified form of the wax.

Specific examples of suitable paraffin waxes and lipidic waxes for use in the disclosure herein may include, but are not limited to, slack wax, beeswax, hydrogenated lipids, refined wax, semi-refined wax, scale wax, microcrystalline wax, beeswax, vegetable-based waxes such as soy and palm waxes, carnauba wax, rice bran wax, montan ester wax, sugar cane wax, sunflower wax, hydrogenated castor oil, poly(3-hydrobuyrate-co-3-hydroxyvalerate), synthetic waxes such as oligomer waxes derived from linear alpha olefins or copolymers thereof, Fischer-Tropsch waxes, polyolefin waxes (e.g., polyethylene wax or polypropylene wax), and any combination thereof. Suitable waxes may be sourced as a wax emulsion in an aqueous fluid, which may then be further formulated with a polymer blend to form the aqueous emulsions described herein. Examples of wax emulsions that may be used in the disclosure herein include, but are not limited to, MICHEM® emulsions such as ME62330, ME93335, ME61335, ME52137, and ME24414 (Michelman). Particularly suitable waxes for use in the disclosure herein may be obtained from a biological source, such as any plant- or animal-based wax listed above, and which is also biodegradable. Thus, in particular embodiments, the wax may comprise at least one biodegradable wax in the disclosure herein. It is to be appreciated, however, that certain synthetic waxes, such as certain Fischer-Tropsch waxes, also allow microplastics-free formulations to be maintained and may similarly be suitable for use in the disclosure herein.

Suitable waxes for incorporation within the aqueous emulsions of the present disclosure may have a melting point of about 50° C. or above and an average diameter, when emulsified, ranging up to about 50,000 nm (50 microns) in size, such as about 300 nm or less, or about 200 nm or less, or about 100 nm or less, preferably an average diameter ranging from about 10 nm to about 100 nm, or about 25 nm to about 50 nm, or about 50 nm to about 90 nm, or about 20 nm to about 75 nm.

Waxes may be present in the aqueous emulsions described herein in an amount up to about 60 wt. %, or up to about 50 wt. %, or up to about 40 wt. %, or up to about 30 wt. %, such as about 5 wt. % to about 40 wt. %, or about 15 wt. % to about 35 wt. %, or about 20 wt. % to about 30 wt. %, as measured based on the mass of total solids within the aqueous emulsions.

The term “shellac” refers to a resinous material obtained from secretions of the female lac bug and comprising oligomers of at least aleuritic acid and shellolic acid. Shellacs suitable for use in the present disclosure may, depending on source and the season of harvest, vary in color and aleuritic acid/shellolic acid ratio. Shellacs may be added to the aqueous fluid or polymer blend when dissolved in a suitable organic solvent, such as ethyl alcohol. In still another alternative, the acidic groups in the shellac may be at least partially neutralized with a base, such as aqueous ammonia, an amine (e.g., ethanolamine, triethanolamine, trimethylamine, diethylamine, dimethylethylamine, triethylamine, and the like) or an alkali metal base (e.g., NaOH, KOH, or the like), and the resulting at least partially neutralized shellac may be combined as an aqueous solution when forming the aqueous emulsions described herein. If less than complete neutralization occurs, the shellac may be ionomeric (i.e., contain both positive and negatively charged groups). If an amine is used to perform the neutralization and excess amine remains present, the excess amine may react with epoxide groups in the film-forming polymer, if present, to promote crosslinking within a coating formed from the aqueous emulsions. When neutralized or partially neutralized shellac is present within an aqueous fluid (e.g., within a neutral or alkaline medium), the ionic charges may aid in promoting dissolution of the shellac therein, and the shellac in the aqueous emulsions may bear one or more ionic charges.

Shellac is available in various grades depending on how purified it is and how dewaxed it is. Less dewaxed shellac is more difficult to disperse in water when at least partially dissolving the shellac. Less purified shellac can result in a darker color. The degree of dewaxing versus purification comes down to acid value and how easily the shellac is dispersed in water. Blonde is a variant of orange shellac with much of the natural shellac dye removed mechanically by filtering with activated carbon. While other grades are bleached chemically (e.g., using sodium hypochlorite) and chemically dissolved in caustic solution (e.g., using sodium carbonate), super blonde or ultra blonde shellac can be quite light colored and more water resistant. Button lac and seed lac are additional shellac grades of shellac that are commonly encountered and may be used herein. Even stick lac, the crudest grade of shellac, may be utilized herein. Any grade of shellac in dewaxed or non-dewaxed form may be suitable for use in the disclosure herein.

In some embodiments, the shellac utilized in the aqueous emulsions and coatings formed therefrom may be an at least partially dewaxed shellac, which may include a fully dewaxed shellac.

The waxy residue obtained following dewaxing of shellac (shellac wax) may be combined with the aqueous emulsions disclosed herein, according to some embodiments. In some embodiments, shellac wax may be utilized as a wax source, optionally in further combination with one or more additional waxes, in aqueous emulsions containing shellac dispersed in an at least partially dissolved form therein. The shellac in such aqueous emulsions may be at least partially dewaxed shellac or non-dewaxed shellac.

Shellac may be present in the aqueous emulsions described herein in an amount up to about 90 wt. %, or up to about 80 wt. %, or up to about 70 wt. %, or up to about 60 wt. %, or up to about 50 wt. %, or up to about 40 wt. %, or up to about 30 wt. %, or up to about 25 wt. %, or up to about 20 wt. %, such as about 20 wt. % to about 90 wt. %, or about 20 wt. % to about 50 wt. %, or about 40 wt. % to about 70 wt. %, or about 1 wt. % to about 25 wt. %, or about 1 wt. % to about 15 wt. %, or about 10 wt. % to about 20 wt. %, or about 15 wt. % to about 30 wt. %, or about 15 wt. % to about 25 wt. %, or about 15 wt. % to about 35 wt. %, or about 20 wt. % to about 40 wt. %, as measured based on the mass of total solids within the aqueous emulsions.

Suitable film-forming polymers may include any polymer that promotes formation of a continuous thin film of substantially uniform thickness once an aqueous emulsion of the present disclosure is introduced upon a surface and subsequently dried. Biodegradability of a film-forming polymer may be evaluated by OECD test method 301D. Other standard test methods that may be suitable for determining biodegradation include OECD test methods 301B, C, or F or OECD test method 310. Film-forming polymers suitable for use in the present disclosure may be natural or synthetic in origin.

Examples of suitable synthetic film-forming polymers exhibiting water solubility and/or biodegradability may include, but are not limited to, a polyethylene glycol, a polyvinyl pyrrolidone, a polyvinyl alcohol, a poly(meth)acrylic acid, a polylactic acid, a polyglycolic acid, any copolymer thereof, or any combination thereof. Suitable copolymers may include any copolymer that permits the parent polymer to maintain water solubility and/or biodegradability, while still promoting effective film formation. Although poly(meth)acrylic acid may be considered to constitute a microplastic in some jurisdictions, this polymer may be used in aqueous emulsions and coatings where a microplastics-free standard need not necessarily be maintained, or a suitable co-monomer may be introduced into poly(meth)acrylic acid to promote water solubility or biodegradability. In more particular embodiments, the film-forming polymer may comprise at least a polyvinyl alcohol. Polyvinyl alcohol and similar polymers may be desirable, in addition to its water solubility, since this polymer may promote at least partial emulsification of other components within the aqueous emulsions disclosed herein.

The film-forming polymer (or multiple film-forming polymers) may be present in the aqueous emulsions described herein in an amount up to about 60 wt. %, or up to about 50 wt. %, or up to about 40 wt. %, or up to about 30 wt. %, or up to about 20 wt. %, or up to about 15 wt. %, or up to about 10 wt. %, or up to about 5 wt. %, such as about 10 wt. % to about 60 wt. %, or about 20 wt. % to about 50 wt. %, or about 5 wt. % to about 25 wt. %, or about 10 wt. % to about 40 wt. %, or about 1 wt. % to about 5 wt. %, or about 2 wt. % to about 8 wt. %, or about 5 wt. % to about 12 wt. %, or about 10 wt. % to about 20 wt. %, as measured based on the mass of total solids within the aqueous emulsions.

Optionally, the aqueous emulsions may further comprise a second film-forming polymer different than the other (first) film-forming polymer, which may be a synthetic polymer that is water-insoluble and/or non-biodegradable in particular examples. However, in order to meet a microplastics-free standard, the second film-forming polymer may also be a synthetic polymer that is water-soluble or biodegradable as well. Suitable examples of the second film-forming polymer are not believed to be particularly limited, other than having the capability for being distributed as emulsified particles in an aqueous emulsion of the present disclosure, optionally being water-soluble and/or biodegradable as well to maintain a microplastic-free profile. In more specific examples, the second film-forming polymer may comprise a polyvinyl acetate polymer or copolymer, such as a polyvinyl pyrrolidone-co-vinyl acetate copolymer (polyvinylpyrrol idone-co-polyvinylacetate). Polyvinyl acetate polymers and copolymers, such as polyvinyl pyrrolidone-co-vinyl acetate copolymer, may be desirable for meeting a microplastics-free standard due to its water solubility, although other biodegradable or water-soluble second film-forming polymers may also be suitable in this regard.

The second film-forming polymer may be present in the aqueous emulsions in an amount that is equal to or less than the amount of the other (first) film-forming polymer, such as polyvinyl alcohol. In more specific examples, the second film-forming polymer may be present in an amount up to about 20 wt. %, or up to about 10 wt. %, or up to about 7.5 wt. %, or up to about 5 wt. %, or up to about 2.5 wt. %, such as about 1 wt. % to about 5 wt. %, or about 2 wt. % to about 8 wt. %, or about 2.5 wt. % to about 5 wt. %, or about 4 wt. % to about 10 wt. %, or about 8 wt. % to about 20 wt. %, as measured based on the mass of total solids within the aqueous emulsions.

Other examples of suitable second film-forming polymers may include those that are commonly used in seed coatings, such as those described in U.S. Pat. No. 10,407,586, incorporated herein by reference. Such film-forming polymers may comprise a copolymer of ethylene and at least one co-monomer such as acrylic acid or derivatives thereof. Again, it is to be emphasized that the second film-forming polymer may be selected such that the aqueous emulsions and coatings formed therefrom either contain microplastics or remain microplastics-free, depending upon whether a particular second film-forming polymer is water-soluble and/or biodegradable and whether a microplastics-free coating is needed for a given application. Any of the following polymers may be functionalized, if needed, to promote water solubility or biodegradability and/or incorporate one or more additional co-monomers to promote water solubility or biodegradability. Moreover, when the aqueous emulsions are being utilized for forming coatings upon surfaces other than seeds (e.g., paper, cardboard, wood, metal (e.g., metal cans) or other types of substrates), other types of second film-forming polymers may be suitable, particularly if a microplastics-free coating is not required to be present.

Still other examples of suitable second film-forming polymers may include one or more polymers comprising at least one acrylate monomer, more particularly at least one acrylate ester. Acrylate monomers may include (meth)acrylate esters, (meth)acrylamides, amine-functionalized (meth)acrylate monomers, polyether-functionalized (meth)acrylate monomers, and the like. Specific examples of suitable acrylate monomers may include, for example, n-butyl (meth)acrylate, isobutyl (meth)acrylate, methyl (meth)acrylate, ethyl (meth)acrylate, 2-ethylhexyl (meth)acrylate, and cycloalkyl (meth)acrylates such as isobornyl (meth)acrylate and cyclohexyl (meth)acrylate, and (meth)acrylamide. Other suitable acrylate monomers may include, for example, hydroxy-functionalized (meth)acrylate monomers such as hydroxyethyl (meth)acrylate and hydroxylpropyl (meth)acrylate; (meth)acrylamide derivatives such as N-methylol (meth)acrylamide and diacetone (meth)acrylamide; diallyl (meth)acrylate and various alkylene glycol di(meth)acrylates. Still other suitable acrylate monomers may include those comprising at least one amine group (e.g., a primary amine, a secondary amine or a tertiary amine) such as, for example, 2-(dimethylamino)ethyl (meth)acrylate, 3-(dimethylamino)propyl (meth)acrylate, 2-(diethylamino)ethyl (meth)acrylate, 3-(diethylamino)propyl (meth)acrylate, 2-(ethylamino)ethyl (meth)acrylate, 3-(ethylamino)propyl (meth)acrylate, 2-(methylamino)ethyl (meth)acrylate, 3-(methylamino)propyl (meth)acrylate, 2-(tert-butylamino)ethyl (meth)acrylate, 3-(tert-butylamino)propyl (meth)acrylate, 2-(dimethylamino)ethyl (meth)acrylamide, 3-(dimethylamino)propyl (meth)acrylamide, 2-(diethylamino)ethyl (meth)acrylamide, 3-(dimethylamino)propyl (meth)acrylamide, 2-(methylamino)ethyl (meth)acrylamide, 3-(methylamino)propyl (meth)acrylamide, 2-(ethylamino)ethyl (meth)acrylamide, 3-(ethylamino)propyl (meth)acrylamide, 2-(tert-butylamino)ethyl (meth)acrylamide, and 3-(tert-butylamino)propyl (meth)acrylamide. Vinyl amine may also represent a suitable monomer in some cases.

The foregoing second film-forming polymers may further comprise another type of ethylenically unsaturated monomer copolymerized with at least one acrylate monomer, such as those provided above. Alpha olefins may be used for this purpose. Suitable alpha olefins that the may be present include, but are not limited to, ethylene, propylene, isobutylene, 1-butene, 1-pentene, 1-hexene, 4-methyl-1-pentene, 1-octene, 1-decene, 1-dodecene, 1-tetradecene, or any combination thereof. Linear alpha olefins having an even number of carbon atoms may be particularly suitable due to their ready commercial availability.

Other examples of monomers that may be copolymerized with at least one acrylate monomer include, for example, styrene or substituted variants thereof; divinyl benzenes; dienes such as 1,3-butadiene and isoprene; vinyl esters, such as vinyl acetate, vinyl alkanoates or their derivatives; nitriles such as (meth)acrylonitrile and fumaronitrile; (meth)acrylamides; and ethylenically unsaturated halides such as vinyl chloride and vinylidene chloride.

Ethylenically unsaturated monomers bearing at least one acidic group may also be present in combination with at least one acrylate monomer, such as those bearing a side chain carboxylic acid or sulfonic acid. Illustrative examples may include, but are not limited to, maleic acid, methyl hydrogen maleate, ethyl hydrogen maleate, itaconic acid, fumaric acid, crotonic acid, citraconic acid, styrenesulfonic acid, and 2-aminomethylpropanesulfonic acid derivatized with a vinyl group. Carboxylic acid forms of the foregoing monomers may be present in an esterified form as well, such as methyl, ethyl, propyl, isopropyl, butyl, isobutyl, t-butyl or like esterified form. Other suitable esterified monomers may comprise an ethylenically unsaturated group in the alcohol-derived portion of the esterified monomer. Such ethylenically unsaturated monomers may include, for example, vinyl acetate, allyl acetate, vinyl propionate, allyl propionate, vinyl benzoate, allyl benzoate, and the like.

In addition to the ethylenically unsaturated polymers and copolymers discussed above, polymers having other types of polymer backbones may also be suitable for use in the aqueous emulsions and coatings of the present disclosure as well. Exemplary polymer backbones suitable for use as film-forming polymers may include, but are not limited to polyesters, polyamides, polyurethanes, polyethers, polyether sulfones, polyetherether ketones, polyimides, polyetherimides, polyetheresters, and the like. Optionally, a co-monomer to promote water-solubility or biodegradability may be included if needed to maintain a microplastics-free state. Rosins, gums, and natural oils may also be suitably used as alternatives to a film-forming polymer as well.

The aqueous emulsions disclosed herein may comprise a suitable plasticizer, which may be biodegradable or non-biodegradable in particular embodiments. Suitable examples for the plasticizer are not believed to be particularly limited, other than being dispersible in an aqueous emulsion of the present disclosure and being capable of promoting robust thin film formation when interacting with the shellac. A suitable plasticizer may also aid in conveying flexibility to the thin film in some cases. Some examples of suitable plasticizers may be derived from a biological source, although non-biologically sourced plasticizers may also be used. Specific examples of suitable plasticizers may include, but are not limited to, epoxidized soybean oil, epoxidized linseed oil, castor oil, tannic acid, milk proteins, polyethylene glycol, or any combination thereof. Still other examples of plasticizers may be suitable such as, for example, epoxidized sunflower oil, cardanol and modified cardanol, glycidol, chlorine- and phosphate-containing vegetable based plasticizers, phosphaphenanthrene-modified vegetable oils, hydroxyl- and nitrogen-group-containing tung oil esters, dimethyl oleate-based plasticizers, citric acid esters, and the like. Surprisingly, in addition to promoting robust thin film formation, inclusion of a suitable plasticizer in the aqueous emulsions disclosed herein may improve dry flow performance and decrease dust off once a coating has been formed.

If included, the plasticizer may be present in the aqueous emulsions described herein in an amount up to about 10 wt. %, or up to about 5 wt. %, or up to about 4 wt. %, or up to about 3 wt. %, or up to about 2 wt. %, or up to about 1 wt. %, such as about 0.1 wt. % to about 1.5 wt. %, or about 0.5 wt. % to about 2 wt. %, or about 0.7 wt. % to about 1.7 wt. %, or about 0.8 wt. % to about 2 wt. %, as measured based on the mass of total solids within the aqueous emulsion. The decision as to whether a plasticizer needs to be included may be based upon desired performance of a coating formed form the aqueous emulsions and whether a second film-forming polymer is present.

Additional components may be present in the aqueous emulsions disclosed herein such as one or more of, for example, effect pigments (colorants), dyes, optical brighteners, crosslinking agents, defoamers, anti-static agents, dispersants, thickeners, fillers, biocides, herbicides, rheology modifiers (e.g., hydrophobically modified ethoxylated polyurethanes and similar rheology-modifying polymers), fluency aids, lubricants, preservatives (e.g., benzoisothiazolinones, methylisothiazolinones, methylchloroisothaizolinones, and the like), coalescent aids, other emulsified polymers, buffers, co-solvents, surfactants, and any combination thereof. Such additional components may be present in amounts conventionally present in aqueous emulsions useful in coating applications. Other examples of additional components that may be present when the aqueous emulsions are utilized for forming a thin-film coating upon seeds may include, but are not limited to, fertilizers, nutrients, moisture modifiers, and the like. All of these additional components need not necessarily be present in a given aqueous emulsion or coating. Zero, one or more than one of each type of additional component may be present in any combination within the aqueous emulsions. For example, there may be at least one or more than one effect pigment, at least one or more than one crosslinking agent, and/or at least one or more than one surfactant. A crosslinking agent may be omitted in some embodiments. Suitable examples of these additional components will be familiar to persons having ordinary skill in the art of emulsion and coating technologies and will not be described in further detail herein.

When used, additional components may be selected independently from one another to modify one or more properties of the aqueous emulsions (e.g., to promote formation of a thin film) or to promote suitability for a given application. For example, when being utilized as a coating for seeds or other surface for which coloration is important, one or more effect pigments or dyes may be present within the aqueous emulsions. In other cases, such as when being used to form a primer coating upon other surfaces such as paper or cardboard, for example, effect pigments, dyes, and other colorants may be optionally omitted. Crosslinking agents may be present or absent when forming a primer coating as well.

Illustrative surfactants that may be suitable for use in the aqueous emulsions disclosed herein are not believed to be particularly limited and may include any of, cationic surfactants, anionic surfactants, neutral surfactants (non-ionic surfactants), zwitterionic surfactants, and any combination thereof. Suitable surfactants may be present in an amount up to about 20 wt. %, or up to about 15 wt. %, or up to about 10 wt. %, or up to about 8 wt. %, or up to about 5 wt. %, or up to about 4 wt. %, or up to about 3 wt. %, or up to about 2 wt. %, or up to about 1 wt. %, or up to about 0.5 wt. %, as measured based upon the mass of total solids in the aqueous emulsion. Illustrative non-ionic surfactants that may be suitable for use in the disclosure herein include, but are not limited to, alkylaryl polyether alcohols, alkylphenol ethoxylates, alkyl ethoxylates, polyoxamers, fatty acid esters (e.g., fatty acid glycerol esters, fatty acid sorbitan esters, fatty acid sorbitol esters, fatty acid lecithin esters, and the like), polyethylene oxide sorbitan fatty acid esters, and any combination thereof. Illustrative anionic surfactants that may be suitable for use in the disclosure herein include, but are not limited to, alkyl ethoxylate sulfates, alkyl ethoxylate sulfonates, alkylphenol ethoxylate sulfates, alkylphenol ethoxylate sulfonates, alkylsulfates, alkylsulfonates, alkylarylsulfates, alkylarylsulfonates, sulfosuccinates, and any combination thereof. Illustrative zwitterionic surfactants that may be suitable for use in the disclosure herein include various betaines and sultaines.

Any of the components within the aqueous emulsions and coatings formed therefrom may be optionally crosslinked, either with an organic crosslinking agent (e.g., an amine in the case of crosslinking an epoxide) or a metal atom that promotes crosslinking through chelation. Suitable examples of crosslinking agents that may promote crosslinking through chelation include, but are not limited to, zinc oxide, magnesium oxide, ammonium zirconium carbonate, and others, such as various transition metal compounds.

Types of surfaces upon which coatings may be formed using the aqueous emulsions of the present disclosure are not believed to be particularly limited, provided that there is adequate adhesion between the surface and the coating. In non-limiting examples, surfaces that may be coated using the aqueous emulsions include, but are not limited to, seeds, paper, cardboard and other types of packaging, wood (e.g., for architectural coatings), metal (e.g., a metal can), other polymers (e.g., within polymer-based circuit board assemblies), and the like. Similarly, the aqueous emulsions described herein may be used to coat sizing upon fibers as well. When used to form a coating upon paper and other substrates in which the coating should be inconspicuous, the aqueous emulsions may be formulated to provide optical clarity once dried as a coating.

In more particular examples, the present disclosure provides coated seeds formed from the aqueous emulsions described herein. Such coated seeds may comprise a base seed, and a thin-film coating formed upon a surface of the base seed. The thin-film coating comprises a wax and a polymer blend comprising shellac, a film-forming polymer that is water-soluble or biodegradable, and, optionally, a plasticizer. The shellac may be distributed as a continuous phase in the thin-film coating. The film-forming polymer may similarly define a continuous phase in the thin-film coating. The film-forming polymer and the shellac may be uniformly intermixed in the continuous phase. In other embodiments, the thin-film coating may lack the wax and comprise a polymer blend comprising shellac, a film-forming polymer that is water-soluble or biodegradable, and, optionally, a plasticizer. The plasticizer may be present in any embodiment of a seed coating disclosed herein. Amounts and more specific examples of these components are provided above. Any of the other optional components described herein may be present within the thin-film coatings as well.

Optionally, the thin-film coatings may further comprise at least one effect pigment in the thin-film coating and/or at least one component of the thin-film coating may be further crosslinked. Components within the thin-film coatings that may be further crosslinked to themselves and/or to other components include, but are not limited to, the shellac, the film-forming polymer, the plasticizer, the wax, or any combination thereof. Examples of suitable crosslinking agents are provided above.

The thin-film coating upon a seed may have a coating weight of about 50 mL to about 200 mL per 45.4 kg of seed. Depending on the seed, the thin-film coating may have a thickness of about 0.5 microns to about 5.0 microns. Examples of seeds that may have a thin-film coating introduced thereto according to the present disclosure include, for example, cereals, vegetables, ornamentals, and fruits. More specific examples of seeds that may be coated according to the disclosure herein include, for instance, soybean seeds, corn seeds, cotton seeds, rice seeds, oat seeds, rye seeds, barley seeds, vegetable seeds, wheat seeds, sunflower seeds, lettuce seeds, spinach seeds, or the like.

Coating thicknesses of thin-film coatings formed upon other types of surfaces according to the present disclosure may range from about 1 μm to about 400 μm, or about 10 μm to about 100 μm, or about 50 μm to about 300 μm, or about 75 μm to about 225 μm. Coating thicknesses may be selected based on their suitability for a given application.

After formation of an aqueous emulsion in accordance with the disclosure above, methods of the present disclosure may further comprise disposing the aqueous emulsion upon a base substrate, such as a plurality of seeds, and removing aqueous fluid from the aqueous emulsion (e.g., by evaporation) while upon the base substrate to form a thin-film coating disposed upon a surface of the base substrate. Optionally, crosslinking of one or more components within the thin-film coating may occur in the course of forming the thin-film coating upon the base substrate. Application of the aqueous emulsion to the base substrate may be achieved using any of a variety of methods such as, for example, immersion, spraying, rod or roller coating, tumbling, or through using equipment such as a size press, water box, blade coater, cast coater, rod coater, air knife coater, curtain coater, film press coater, flexo coater, the like, or any combination thereof. Beyond seeds, any other type of base substrate, such as cardboard, paper, wood, or metal (e.g., a metal can), for example, may be coated as well.

In non-limiting examples, the thin-film coating may be formed using a batch coater, a drum coater, or the like. In other non-limiting examples, the thin-film coating may be formed by spraying. The chosen coating method may depend on the particular type of seed or other type of surface to be coated.

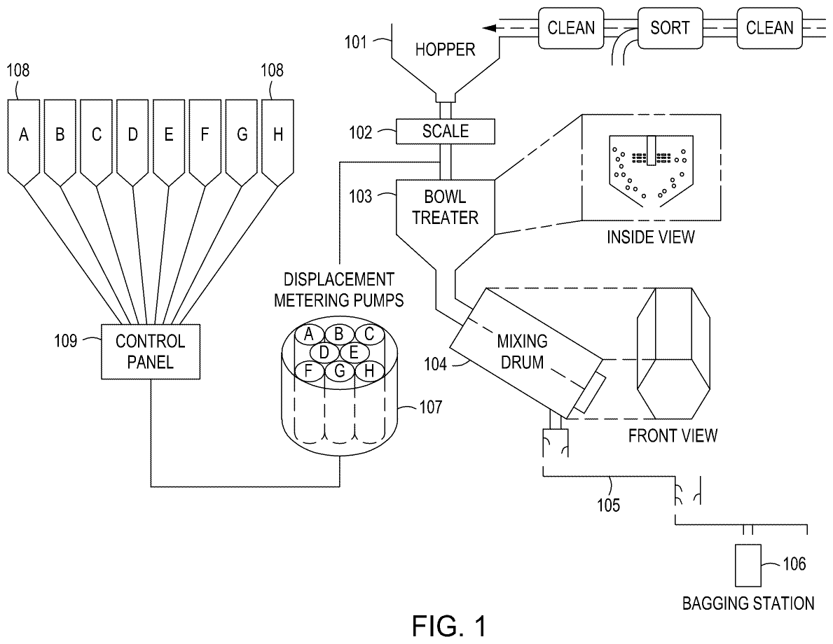

FIG. 1 is a diagram of an illustrative system for coating seeds using a drum coater according to various embodiments of the present disclosure. As shown in FIG. 1, seeds are cleaned, sorted, and added to supply hopper 101. The seeds flow through supply hopper 101 to scale 102 and into bowl treater 103. Supply hopper 101 and scale 102 control the rate of seed flow into bowl treater 103. In bowl treater 103, the seeds pass through a zone of sprayed or atomized coating material. The seeds then pass from bowl treater 103 into mixing drum 104.

Mixing drum 104 rotates the seeds and the seed coating components, thereby ensuring that each seed is substantially completely coated with the seed coating. Evaporation of the aqueous fluid may take place during the course of this process, thereby leaving the other components disposed upon the outer surface of the seed as the thin-film coating. Heating and/or application of vacuum may take place in some instances to promote more rapid evaporation of the aqueous fluid. The coated seeds then exit through an opening of mixing drum 104. Coated seeds exiting mixing drum 104 may contact one or more conveyor belts 105 which transport the seeds to bagging station 106.

The drum coater may include one or more of metering pump 107 that provides the aqueous emulsion to bowl treater 103. In particular, metering pump 107 draws the aqueous emulsion from one or more tanks 108 as directed by control panel 109.

It is to be appreciated that seed coatings having a composition as described herein need not necessarily be deposited from a single aqueous emulsion as defined above. That is, one or more components of the thin-film coating may be applied to a plurality of seeds, optionally in emulsified form, individually or together with an aqueous emulsion lacking those one or more components. Accordingly, the components that make up a thin-film coating upon a seed or other type of surface may be coated on the seed or other surface simultaneously or substantially simultaneously independent of whether or not they are mixed together in a single aqueous emulsion prior to coating. Alternately, the components of the thin-film coating may be applied to the seed or surface separately from one another at different times.

Although the foregoing has described one or more embodiments that feature spraying of an aqueous emulsion onto a plurality of seeds, it should be understood that any suitable coating process may be used. As but one example, the seeds may be directly mixed with the aqueous emulsion or a similar coating composition. In still other embodiments, the seeds may be tumbled with the aqueous emulsion, film coated, pelleted, encrusted, or the like. Other types of coatings, for example, may be formed by immersion (dip coating) of a suitable substrate in an aqueous emulsion and then removing solvent to form a coating upon the substrate.

Accordingly, coating methods for seeds according to the present disclosure may comprise: providing a plurality of seeds, contacting the plurality of seeds with an aqueous emulsion of the present disclosure, and removing the aqueous fluid to produce a plurality of coated seeds comprising a thin-film coating. The thin-film coating comprises a wax, and a polymer blend comprising shellac, a film-forming polymer that is water-soluble or biodegradable, and an optional plasticizer. The shellac may be distributed as a continuous phase in the thin-film coating along with the first film-forming polymer. The wax may be present as a discontinuous phase within the thin-film coating. The film-forming polymer and the shellac may be intermixed with one another in the continuous phase of the thin-film coating. Optionally, any of these components may be further crosslinked with themselves or with one or more additional components once the thin-film coating has been formed upon a seed or other suitable coating surface. Removal of the aqueous fluid may comprise evaporation of the aqueous fluid from the surface of the seeds once the aqueous emulsion has been deposited upon the surface of the seeds, optionally assisted by application of heat and/or vacuum. Deposition of the aqueous emulsion upon the surface of the seeds may comprise spraying the aqueous emulsion onto the plurality of seeds, tumbling the aqueous emulsion with the plurality of seeds, or any combination thereof.

Embodiments disclosed herein include:

A. Aqueous emulsions. The aqueous emulsions comprise: an aqueous fluid; a wax; and a polymer blend comprising shellac, a first film-forming polymer that is water-soluble or biodegradable, and, optionally, a plasticizer; wherein the wax and the polymer blend are dispersed in the aqueous fluid.

A1. Aqueous emulsions comprising: an aqueous fluid; and a polymer blend comprising shellac, a first film-forming polymer that is water-soluble or biodegradable, and, optionally, a plasticizer; wherein the wax and the polymer blend are dispersed in the aqueous fluid.

B. Coated substrates. The coated substrates comprise: a base substrate; and a thin-film coating formed upon a surface of the base substrate and comprising: a wax, and a polymer blend comprising shellac, a first film-forming polymer that is water-soluble or biodegradable, and, optionally, a plasticizer.

B1. Coated substrates. The coated substrates comprise: a base substrate; and a thin-film coating formed upon a surface of the base substrate and comprising: a polymer blend comprising shellac, a first film-forming polymer that is water-soluble or biodegradable, and, optionally, a plasticizer.

C. Coated seeds. The coated seeds comprise: a base seed; and a thin-film coating formed upon a surface of the base seed and comprising: a wax, and a polymer blend comprising shellac, a first film-forming polymer that is water-soluble or biodegradable, and, optionally, a plasticizer.

C1. Coated seeds. The coated seeds comprise: a base seed; and a thin-film coating formed upon a surface of the base seed and comprising: a polymer blend comprising shellac, a first film-forming polymer that is water-soluble or biodegradable, and, optionally, a plasticizer.

D. Coating methods. The coating methods comprise: providing a base substrate; contacting the base substrate with the aqueous emulsion of A or A1; and removing the aqueous fluid to produce a coated substrate comprising a thin-film coating comprising the wax, and the polymer blend comprising the shellac, the film-forming polymer that is water-soluble or biodegradable, and, optionally, the plasticizer.

D1. Seed coating methods. The seed coating methods comprise: providing a plurality of seeds; contacting the plurality of seeds with the aqueous emulsion of A or A1; and removing the aqueous fluid to produce a plurality of coated seeds comprising a thin-film coating comprising the wax, and the polymer blend comprising the shellac, the film-forming polymer that is water-soluble or biodegradable, and, optionally, the plasticizer.

E. Polymer blends. The polymer blends comprise shellac; a film-forming polymer that is water-soluble or biodegradable; and a plasticizer.

Each of embodiments A, A1, B, B1, C, C1, D, D1 and E may have one or more of the following additional elements in any combination:

Element 1: wherein the first film-forming polymer comprises a polyvinyl alcohol, a polylactic acid, a polyglycolic acid, or any combination thereof.

Element 2: wherein the first film-forming polymer comprises at least a polyvinyl alcohol.

Element 3: wherein the plasticizer is biodegradable.

Element 4: wherein the plasticizer comprises epoxidized soybean oil, castor oil, tannic acid, milk proteins, or any combination thereof.

Element 5: wherein the aqueous emulsion further comprises at least one effect pigment.

Element 5A: wherein the thin-film coating further comprises at least one effect pigment.

Element 6: wherein the aqueous emulsion further comprises at least one crosslinking agent.

Element 6A: wherein at least one component of the thin-film coating is further crosslinked.

Element 7: wherein the aqueous fluid contains about 10 wt. % to about 60 wt. % solids, based on total mass of the aqueous emulsion.

Element 8: wherein the aqueous emulsion further comprises a second film-forming polymer different from the first film-forming polymer, optionally wherein the second film-forming polymer comprises polyvinylpyrrolidone-co-polyvinylacetate.

Element 9: wherein the wax does not constitute a microplastic.

Element 10: wherein the aqueous emulsion further comprises at least one surfactant, at least one biocide, or any combination thereof.

Element 10A: wherein the thin-film coating further comprises one or more of: at least one surfactant, at least one biocide, or any combination thereof.

Element 11: wherein the plasticizer is present.

Element 12: wherein contacting comprises spraying the aqueous emulsion onto the plurality of seeds, or tumbling the plurality of seeds with the aqueous emulsion.

By way of non-limiting example, exemplary combinations applicable to A, A1, B, B1, C, C1, D, D1, and E include, but are not limited to, 1 or 2, and 3; 1 or 2, and 4; 1 or 2, and 5 or 5A; 1 or 2, and 6 or 6A; 1 or 2, 5 or 5A, and 6 or 6A; 1 or 2, and 7; 1 or 2, and 8; 1 or 2, and 9; 1 or 2, and 10 or 10A; 1 or 2, and 11; 3 and 4; 3, and 5 or 5A; 3, and 6 or 6A; 3, 5 or 5A, and 6 or 6A; 3 and 7; 3 and 8; 3 and 9; 3, and 10 or 10A; 3 and 11; 4, and 5 or 5A; 4, and 6 or 6A; 4, 5 or 5A, and 6 or 6A; 4 and 7; 4 and 8; 4 and 9; 4, and 10 or 10A; 4 and 11; 5 or 5A, and 6 or 6A; 5 or 5A, and 7; 5 or 5A, and 8; 5 or 5A, and 9; 5 or 5A, and 10 or 10A; 5 or 5A, and 11; 6 or 6A, and 7; 6 or 6A, and 8; 6 or 6A, and 9; 6 or 6A, and 10 or 10A; 6 or 6A, and 11; 7 and 8; 7 and 9; 7, and 10 or 10A; 7 and 11; 8 and 9; 8, and 10 or 10A; 8 and 11; 9, and 10 or 10A; 9 and 11; and 10 and 11. Any of the foregoing may be in further combination with 14, or any one of 1, 2, 3, 4, 5, 5A, 6, 6A, 7, 8, 9, 10, 10A, or 11 alone.

The present disclosure is further directed to the following non-limiting clauses.
Clause 1. An aqueous emulsion comprising:
   an aqueous fluid;
   a wax; and
   a polymer blend comprising shellac, a first film-forming polymer that is water-soluble or biodegradable, and, optionally, a plasticizer;
      wherein the wax is emulsified as solids in the aqueous fluid, and the polymer blend is at least partially dissolved in the aqueous fluid.
Clause 2. The aqueous emulsion of clause 1, wherein the first film-forming polymer comprises a polyvinyl alcohol, a polylactic acid, a polyglycolic acid, or any combination thereof.
Clause 3. The aqueous emulsion of clause 1, wherein the first film-forming polymer comprises at least a polyvinyl alcohol.
Clause 4. The aqueous emulsion of clause 1, wherein the plasticizer is present.
Clause 5. The aqueous emulsion of clause 4, wherein the plasticizer is biodegradable.
Clause 6. The aqueous emulsion of clause 4, wherein the plasticizer comprises epoxidized soybean oil, castor oil, tannic acid, milk proteins, or any combination thereof.
Clause 7. The aqueous emulsion of clause 1, further comprising: at least one effect pigment.
Clause 8. The aqueous emulsion of any one of clauses 1-7, further comprising:
   at least one crosslinking agent.
Clause 9. The aqueous emulsion of any one of clauses 1-7, wherein the aqueous fluid contains about 10 wt. % to about 60 wt. % solids, based on total mass of the aqueous emulsion.
Clause 10. The aqueous emulsion of any one of clauses 1-7, further comprising:
   a second film-forming polymer different from the first film-forming polymer, optionally wherein the second film-forming polymer comprises polyvinylpyrrolidone-co-polyvinylacetate.
Clause 11. The aqueous emulsion of any one of clauses 1-7, wherein the wax does not constitute a microplastic.
Clause 12. The aqueous emulsion of any one of clauses 1-7, further comprising one or more of:
   at least one surfactant, at least one biocide, or any combination thereof.
Clause 13. The aqueous emulsion of any one of clauses 1-7, wherein the shellac is at least partially neutralized with a base.
Clause 14. The aqueous emulsion of clause 13, wherein the base comprises at least one base selected from the group consisting of aqueous ammonia, an amine, an alkali metal hydroxide, or any combination thereof.
Clause 15. A coated seed comprising:
   a base seed; and
   a thin-film coating formed upon a surface of the base seed and comprising:
      a wax, and a polymer blend comprising shellac, a first film-forming polymer that is water-soluble or biodegradable, and, optionally, a plasticizer;
         wherein the shellac is distributed as a continuous phase in the thin-film coating.
Clause 16. The coated seed of clause 15, wherein the first film-forming polymer comprises a polyvinyl alcohol, a polylactic acid, a polyglycolic acid, or any combination thereof.
Clause 17. The coated seed of clause 15, wherein the plasticizer is present.
Clause 18. The coated seed of clause 17, wherein the plasticizer comprises epoxidized soybean oil, castor oil, tannic acid, milk proteins, or any combination thereof.
Clause 19. The coated seed of any one of clauses 15-18, wherein the thin-film coating further comprises at least one effect pigment.
Clause 20. The coated seed of any one of clauses 15-18, wherein at least one component of the thin-film coating is further crosslinked.
Clause 21. The coated seed of any one of clauses 15-18, wherein the wax does not constitute a microplastic.
Clause 22. The coated seed of any one of clauses 15-18, wherein the thin-film coating further comprises one or more of:
   at least one surfactant, at least one biocide, or any combination thereof.
Clause 23. The coated seed of any one of clauses 15-18, wherein the shellac is at least partially neutralized with a base.
Clause 24. The coated seed of clause 23, wherein the base comprises at least one base selected from the group consisting of aqueous ammonia, an amine, an alkali metal hydroxide, or any combination thereof.
Clause 25. A method comprising:
   providing a plurality of seeds;
   contacting the plurality of seeds with the aqueous emulsion of any one of clauses 1-7; and
   removing the aqueous fluid to produce a plurality of coated seeds comprising a thin-film coating comprising the wax, the shellac, the film-forming polymer that is water-soluble or biodegradable, and, optionally, the plasticizer.
Clause 26. The method of clause 25, wherein contacting comprises spraying the aqueous emulsion onto the plurality of seeds, or tumbling the plurality of seeds with the aqueous emulsion.
Clause 27. The method of clause 25, wherein at least one component of the thin-film coating is further crosslinked.
Clause 28. The method of clause 25, wherein the shellac is distributed as a continuous phase in the thin-film coating.
Clause 29. The method of clause 25, wherein the shellac is at least partially neutralized with a base.
Clause 30. The method of clause 29, wherein the base comprises at least one base selected from the group consisting of aqueous ammonia, an amine, an alkali metal hydroxide, or any combination thereof.
Clause 31. A polymer blend comprising:
   shellac;
   a film-forming polymer that is water-soluble or biodegradable; and
   a plasticizer.

To facilitate a better understanding of the disclosure herein, the following examples of various representative embodiments are given. In no way should the following examples be read to limit, or to define, the scope of the present disclosure.

### EXAMPLES

An experimental polymer blend (Polymer Blend #1) was formulated with the following composition (wt. % with respect to total mass of the polymer blend): shellac (66%), polyvinyl alcohol (19%), polyvinyl acetate-polyvinyl pyrollidone copolymer (8%), epoxidized soybean oil plasticizer (4%), and deionized water (3%). The polymer blend was then mixed with additional water and further components as specified in Table 1 below for Samples 1-4. Rice bran wax was used in most instances, although carnauba wax and Fischer-Tropsch waxes were also tested. The shellac was present in dissolved form following emulsification.

A first comparative polymer blend (Polymer Blend #2) was formulated identically to Polymer Blend #1, except the epoxidized soybean oil plasticizer was omitted. In this case, the composition was as follows (wt. % with respect to total mass of the polymer blend): shellac (69%), polyvinyl alcohol (20%), polyvinyl acetate copolymer (8%), and water (3%). The first comparative polymer blend was then mixed with additional water and further components as specified in Table 2 below for Samples 5-8 (all comparative samples). The shellac was present in dissolved form following emulsification.

TABLE 1

| Sample | Sample | Sample | Sample |
|---|---|---|---|
| 1 | 2 | 3 | 4 |

(wt. % by total mass)

| | | | | |
|---|---|---|---|---|
| Wax | 25 | 24 | 25 | 22 |
| Polymer Blend | 32 | 31 | 32 | 31 |
| Water | 14 | 12 | 15 | 17 |
| Pigment(s) | 19 | 19 | 19 | 19 |
| Dispersant | 0.3 | 0.3 | 0.3 | 0.3 |
| Wetting Agent | 0.2 | 0.2 | 0.2 | 0.2 |
| Rheology Modifier | 0.3 | 0.3 | 0.3 | 0.3 |
| Biocide | 0.1 | 0.1 | 0.1 | 0.1 |
| Defoamer | 0.1 | 0.1 | 0.1 | 0.1 |
| Anti-Freeze Agent | 6 | 6 | 6 | 6 |
| Further Additives | 3 | 7 | 2 | 4 |
| Total | 100 | 100 | 100 | 100 |

TABLE 2

| Sample | Sample | Sample | Sample |
|---|---|---|---|
| 5 | 6 | 7 | 8 |

(wt. % by total mass)

| | | | | |
|---|---|---|---|---|
| Wax | 27.5 | 27 | 28 | 29 |
| Polymer Blend | 30.7 | 30 | 32 | 32 |
| Water | 12 | 12 | 11 | 10 |
| Pigment(s) | 19 | 18 | 17 | 14 |
| Dispersant | 0.3 | 0.3 | 0.3 | 0.3 |
| Wetting Agent | 0.3 | 0.2 | 0.2 | 0.2 |
| Rheology Modifier | 0.1 | 0.3 | 0.3 | 0.3 |
| Biocide | 0.1 | 0.1 | 0.1 | 0.1 |
| Defoamer | 0.1 | 0.1 | 0.1 | 0.1 |
| Anti-Freeze Agent | 6 | 6 | 6 | 6 |
| Further Additives | 3.9 | 6 | 5 | 8 |
| Total | 100 | 100 | 100 | 100 |

A second set of comparative samples was prepared similarly by substituting only synthetic polymer for the shellac/polyvinyl alcohol/epoxidized soybean oil blend, as specified in Table 3 below.

TABLE 3

| | |
|---|---|
| Sample 9 | Sample 10 |

(wt. % by total mass)

| | | |
|---|---|---|
| Wax | 18 | 17 |
| Synthetic Polymer | 27 | 26 |
| Water | 11 | 10 |
| Pigment(s) | 31 | 30 |
| Dispersant | 2.7 | 2.6 |
| Wetting Agent | 0.9 | 0.9 |
| Rheology Modifier | 0.05-0.1 | 0.05-0.1 |
| Biocide | 0.2 | 0.2 |
| Defoamer | 0.1 | 0.1 |
| Further Additives | 9 | 13 |
| Total | 100 | 100 |

Seed Coating Procedure. Aqueous emulsions prepared as above (Tables 1-3) were then coated onto corn or soybean seeds using standard seed coating procedures. In brief, 10 grams of the aqueous emulsion was contacted with 1 kg of seeds in a standard seed coating apparatus. After 30 seconds of contact, the seeds were recovered from the seed coater and allowed to dry 18-24 hours.

Once the coating had dried upon the surfaces of the individual seeds, further testing was performed to evaluate dry flow and dust formation (dust off) performance of the coated seeds. For measuring dry flow performance, 400 g of seeds were placed in the seed flow meter. Flow was measured as the mass of seeds that flowed through the meter in 0.4 seconds. Dividing the mass by the flow time provided the reported dry flow rates. Dry flow measurements were conducted 8 times, and the results were averaged. For Heubach dust off performance, 100 g of seeds were placed in a Heubach dust off apparatus, along with a pre-weighed filter. After 300 cycles of rotation, the seeds and the filter were each weighed. The mass collected on the filter was utilized to determine the reported dust off values.

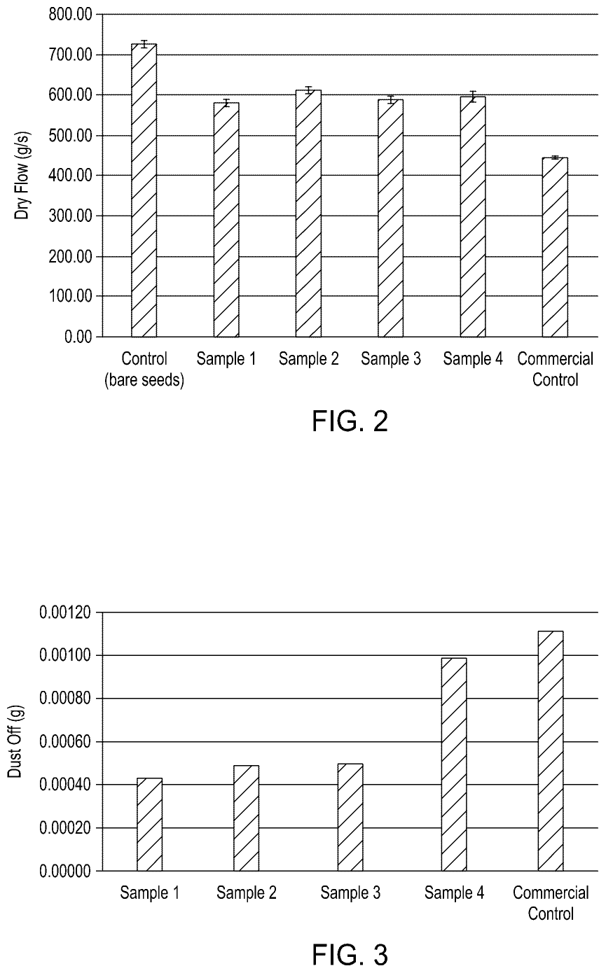

FIG. 2 is a plot of dry flow performance of seeds coated using the aqueous emulsions of Samples 1-4. As shown, minor variations in the amounts of additional components in the aqueous emulsions resulted in only negligible variation of the dry flow performance. The dry flow performance of the experimental coatings was slightly better (higher) than that afforded by a commercial coating formulation containing microplastics but slightly lower than that of uncoated seeds.

FIG. 3 is a plot of Heubach dust off performance of seeds coated using the aqueous emulsions of Samples 1-4. The values are reported as absolute mass difference after 5 minutes of run time. As shown, Sample 4 afforded comparable dust off performance to that of a commercial control. Samples 1-3 afforded superior (lower) dust off values compared to the commercial control.

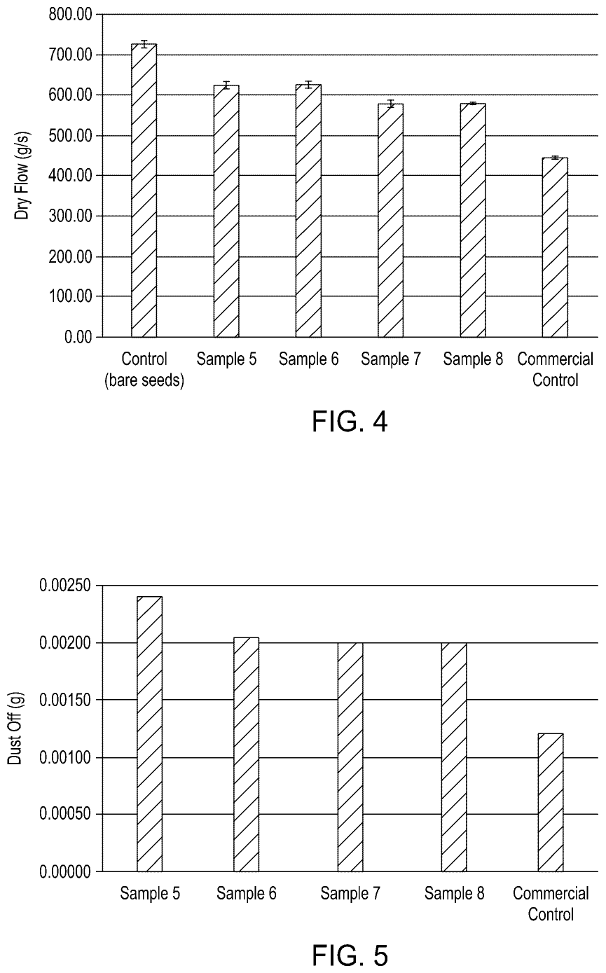

When the epoxidized soybean oil plasticizer was omitted from the samples, somewhat poorer dust control performance was realized. FIG. 4 is a plot of dry flow performance of seeds coated with the aqueous emulsions of Samples 5-8. As shown, dry flow values increased when the plasticizer was omitted and were higher than the commercial control. FIG. 5 is a plot of Heubach dust off performance of seeds coated using the aqueous emulsions of Samples 5-8. Although better dry flow performance was realized when omitting the plasticizer, dust off values were poorer for coated seeds lacking the plasticizer. In addition, coatings lacking the plasticizer were more brittle than those obtained when the plasticizer was present.

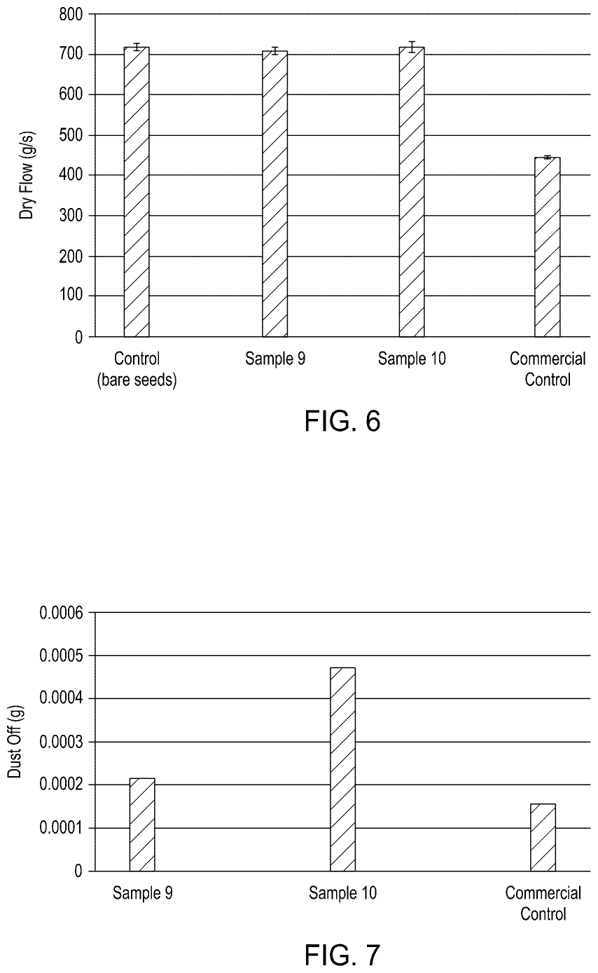

When the shellac/polyvinyl alcohol/epoxidized soybean oil blend was replaced by a synthetic polymer, comparable or slightly better dry flow and dust off performance was realized in comparison to the samples containing the shellac/polyvinyl alcohol/epoxidized soybean oil blend. However, samples lacking the shellac/polyvinyl alcohol/epoxidized soybean oil blend are not free of microplastics. FIG. 6 is a plot of dry flow performance of seeds coated with the aqueous emulsions of Samples 9 and 10. FIG. 7 is a plot of Heubach dust off performance of seeds coated using the aqueous emulsions of Samples 9 and 10.

Samples replacing all or part of the polyvinyl alcohol or polyvinyl acetate copolymer with functionalized biopolymers, such as carboxymethyl cellulose or hydroxypropyl methylcellulose, exhibited thixotropic rheology and high viscosity and were not readily coated upon seeds (data not shown).

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. An aqueous emulsion comprising:
an aqueous fluid;
a wax; and
a polymer blend comprising shellac, a first film-forming polymer that is water-soluble or biodegradable, and, optionally, a plasticizer;
wherein the wax is emulsified as solids in the aqueous fluid, and the polymer blend is at least partially dissolved in the aqueous fluid.

2. The aqueous emulsion of claim 1, wherein the first film-forming polymer comprises a polyvinyl alcohol, a polylactic acid, a polyglycolic acid, or any combination thereof.

3. (canceled)

4. The aqueous emulsion of claim 1, wherein the plasticizer is present.

5. The aqueous emulsion of claim 4, wherein the plasticizer is biodegradable.

6. The aqueous emulsion of claim 4, wherein the plasticizer comprises epoxidized soybean oil, castor oil, tannic acid, milk proteins, or any combination thereof.

7. The aqueous emulsion of claim 1, further comprising:
at least one effect pigment.

8. The aqueous emulsion of claim 1, further comprising:
at least one crosslinking agent.

9. The aqueous emulsion of claim 1, wherein the aqueous fluid contains about 10 wt. % to about 60 wt. % solids, based on total mass of the aqueous emulsion.

10. The aqueous emulsion of claim 1, further comprising:
a second film-forming polymer different from the first film-forming polymer, optionally wherein the second film-forming polymer comprises polyvinylpyrrolidone-co-polyvinylacetate.

11. (canceled)

12. (canceled)

13. The aqueous emulsion of claim 1, wherein the shellac is at least partially neutralized with a base.

14. The aqueous emulsion of claim 13, wherein the base comprises at least one base selected from the group consisting of aqueous ammonia, an amine, an alkali metal hydroxide, or any combination thereof.

15. A coated seed comprising:
a base seed; and
a thin-film coating formed upon a surface of the base seed and comprising:
a wax, and a polymer blend comprising shellac, a first film-forming polymer that is water-soluble or biodegradable, and, optionally, a plasticizer;
wherein the shellac is distributed as a continuous phase in the thin-film coating.

16. The coated seed of claim 15, wherein the first film-forming polymer comprises a polyvinyl alcohol, a polylactic acid, a polyglycolic acid, or any combination thereof.

17. The coated seed of claim 15, wherein the plasticizer is present.

18. The coated seed of claim 17, wherein the plasticizer comprises epoxidized soybean oil, castor oil, tannic acid, milk proteins, or any combination thereof.

19. The coated seed of claim 15, wherein the thin-film coating further comprises at least one effect pigment.

20. The coated seed of claim 15, wherein at least one component of the thin-film coating is further crosslinked.

21. (canceled)

22. (canceled)

23. The coated seed of claim 15, wherein the shellac is at least partially neutralized with a base.

24. The coated seed of claim 23, wherein the base comprises at least one base selected from the group consisting of aqueous ammonia, an amine, an alkali metal hydroxide, or any combination thereof.

25. A method comprising:
providing a plurality of seeds;
contacting the plurality of seeds with the aqueous emulsion of claim 1; and
removing the aqueous fluid to produce a plurality of coated seeds comprising a thin-film coating comprising the wax, the shellac, the film-forming polymer that is water-soluble or biodegradable, and, optionally, the plasticizer.

26. The method of claim 25, wherein contacting comprises spraying the aqueous emulsion onto the plurality of seeds, or tumbling the plurality of seeds with the aqueous emulsion.

27. The method of claim 25, wherein at least one component of the thin-film coating is further crosslinked.

28. The method of claim 25, wherein the shellac is distributed as a continuous phase in the thin-film coating.

29. The method of claim 25, wherein the shellac is at least partially neutralized with a base.

30. The method of claim 29, wherein the base comprises at least one base selected from the group consisting of aqueous ammonia, an amine, an alkali metal hydroxide, or any combination thereof.

31. (canceled)
